(19) United States
(12) Patent Application Publication
(10) Pub. No.: US 2010/0309981 A1
(43) Pub. Date: Dec. 9, 2010

(54) REUSE OF A SEARCH REGION IN MOTION ESTIMATION OF MULTIPLE TARGET FRAMES

(75) Inventors: SOYEB NAGORI, Bangalore (IN); Arun Shankar Kudana, Bangalore (IN); Ajit Venkat Rao, Bangalore (IN)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 12/477,963

(22) Filed: Jun. 4, 2009

(51) Int. Cl. H04N 7/26

(52) U.S. Cl. 375/240.16; 375/E07.123

(57) ABSTRACT

Several methods and a system to reuse a search region in motion estimation of multiple target frames are disclosed. In an embodiment, a method includes acquiring a search region of a reference frame. The method also includes maintaining the search region in a memory. In addition, the method includes performing motion estimation of a macroblock of a target frame in a direction using a processor and the search region. The method also includes reusing the search region maintained in the memory to perform motion estimation of an additional macroblock of an additional target frame in an additional direction. The method may include reusing the search region maintained in the memory to perform motion estimation of a separate macroblock of a separate target frame in a separate direction.

### FIELD OF TECHNOLOGY

This disclosure relates generally to fields of video technology, and more particularly to reuse of a search region in motion estimation of multiple target frames.

### BACKGROUND

An encoder may perform motion estimation and encoding of a macroblock of a frame. The encoder may use a two window approach in which a search window of a prior frame and an additional search window of a later frame are used to perform motion estimation of the macroblock. The encoder may require additional bandwidth and additional memory to perform motion estimation using the two window approach. As a result, a size of a search window may be reduced. In addition, a loss of quality in the encoding may occur, resulting in a lower quality transmission or recording.

### SUMMARY

This summary is provided to comply with 37 C.F.R. §1.73, requesting a summary of the invention briefly indicating the nature and substance of the invention. It is submitted with the understanding that it will not be used to limit the scope or meaning of the claims.

Several methods and a system to reuse a search region in motion estimation of multiple target frames are disclosed.

In an exemplary embodiment, a method includes acquiring a search region of a reference frame. The method also includes maintaining the search region in a memory. The method also includes performing motion estimation of a macroblock of a target frame in a direction using a processor and the search region. In addition, the method includes reusing the search region maintained in the memory to perform motion estimation of an additional macroblock of an additional target frame in an additional direction.

In an exemplary embodiment, a system includes a motion estimation module to acquire a search region of a reference frame. In addition, the system includes a memory to maintain the search region. The system also includes a processor to perform motion estimation of a macroblock of a target frame in a direction using the search region. The system also includes the processor to reuse the search region maintained in the memory to perform motion estimation of an additional macroblock of an additional target frame in an additional direction.

In an exemplary embodiment, a method includes acquiring a search region of a reference frame. The method further includes maintaining the search region in a memory. The method also includes determining a motion estimation predictor using the reference frame. The motion estimation of the macroblock of the target frame utilizes the motion estimation predictor. In the embodiment, the reference frame and the target frame are adjacent frames.

In the embodiment, the method includes performing motion estimation of a macroblock of a target frame in a direction using a processor and the search region. At least two of the macroblock, an additional macroblock, and a separate macroblock are collocated. The method also includes reusing the search region maintained in the memory to perform motion estimation of the additional macroblock of an additional target frame in an additional direction. The method includes reusing the search region maintained in the memory to perform motion estimation of the separate macroblock of a separate target frame in a separate direction. In the embodiment, the direction of motion estimation, the additional direction of motion estimation, and the separate direction of motion estimation is forward. In addition, the target frame and the additional target frame are each B-frames, and the separate target frame is a P-frame.

The method further includes acquiring a previously determined motion estimation data of the target frame. The previously determined motion estimation data is generated by performing an alternate direction of motion estimation on the macroblock of the target frame using an alternate search region of an alternate reference frame. The method also includes selecting at least one of a forward mode, a backward mode, and a bipredictive mode as a preferred motion estimation method of the target frame. The method further includes performing a real time encoding of the macroblock of the target frame. The real time encoding is performed after the alternate search region is maintained in the memory and reused to perform motion estimation of multiple frames.

The methods, systems, and apparatuses disclosed herein may be implemented in any means to achieve various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a block diagram of a system to perform reuse of a search region in motion estimation, according to one embodiment.

FIG. 2 illustrates pipelining of motion estimation and encoding while reusing a search region, according to one embodiment.

FIG. 3 is a diagrammatic system view of a data processing system in which any of the embodiments disclosed herein may be performed, according to one embodiment.

FIG. 4A is a process flow illustrating reuse of the search region to perform motion estimation, according to one embodiment.

FIG. 4B is a continuation of the process flow of FIG. 4A illustrating additional operations, according to one embodiment.

Other features of the present embodiments will be apparent from the accompanying Drawings and from the Detailed Description that follows.

### DETAILED DESCRIPTION

Several methods and a system to reuse a search region in motion estimation of multiple target frames are disclosed.

Although the present embodiments have been described with reference to specific example embodiments, it will be evident that various modifications and changes may be made to these embodiments without departing from the broader spirit and scope of the various embodiments.

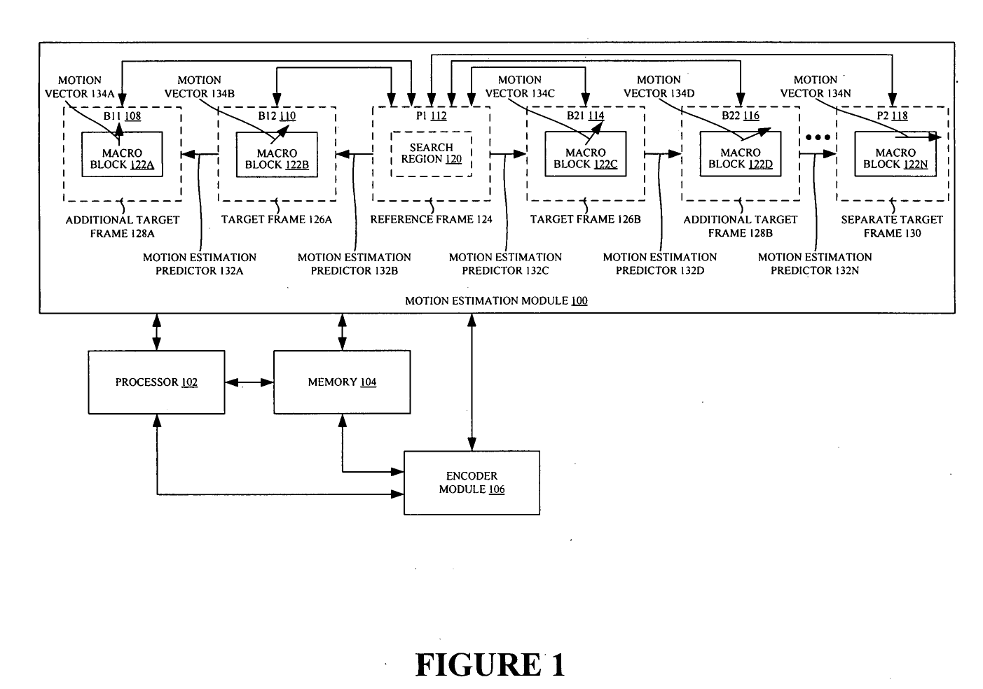

FIG. 1 is a block diagram of a system to perform reuse of a search region in motion estimation, according to one embodiment. In particular, FIG. 1 illustrates a motion estimation module 100, a processor 102, a memory 104, an encoder module 106, a B11 108 frame, a B12 110 frame, a P1 112 frame, a B21 114 frame, a B22 116 frame, a P2 118 frame, a search region 120, a macroblock 122A-N, a reference frame 124, a target frame 126A-B, an additional target frame 128A-B, a separate target frame 130, a motion estimation predictor 132A-N, and a motion vector 134A-N, according to one embodiment.

Compression of video data may involve intra frame coding using an I-frame, predictive frame coding using a P-frame, or bipredictive frame coding using a B-frame. The P-frame may be P1 112 or P2 118. The B-frame may be one of B11 108, B12 110, B21 114, or B22 116. The I-frame may be coded by itself. A macroblock 122N of a P-frame may be predicted using motion estimation from a recently coded frame. A macroblock 122A-D of a B-frame may be bipredictively coded using a combination of data from two previously coded frames. P-frames may be coded in temporal order, which may be the order in which the frames occurred. B-frames may be coded using a frame that occurred temporally later and a frame that occurred temporally earlier.

Video frames that occur within a threshold time period or a threshold number of frames may use the same reference data to perform motion estimation. The threshold time period or the threshold number of frames may be affected by the video coding standard, available memory, processor limitations, and any applicable time limits with respect to completing motion estimation and encoding. Different B-frames may use the same reference data to perform either forward or reverse motion estimation, depending on whether the reference frame 124 occurred later in time or earlier in time than a particular target B-frame.

Motion estimation and motion compensation may be delinked at a frame level from other encoding processes to allow one or more pixels of a search region to be reused. The other encoding processes may include a transform module, an entropy coder module, an intraprediction module, and a quantization module. The transform module may perform a Fourier transform operation or an inverse Fourier transform operation. The intraprediction module may perform a prediction operation with respect to an intra coded frame. The quantization module may perform quantization.

A reference frame may be stored in external memory, which may be a non-volatile or volatile memory, or any other storage medium. A search region 120 of the reference frame may be transferred from the external memory and maintained in internal memory 104. The search region 120 may be reused to provide reference data, which may be used to perform motion estimation. Maintaining and reusing the search region 120 in the internal memory 104 may reduce a bandwidth needed to transfer the same search region 120 data between external memory and the internal memory 104. The reduction in bandwidth may allow an increased search region 120 to be used in motion estimation, which may result in an increased quality of video compression.

In an example embodiment, a standard group of picture (“GOP”) structure may be used with respect to a series of video frames. The structure may be a “PBBP” sequence, in which a P-frame is followed by one or more B-frames, which may be followed by another P-frame. In an embodiment, the frames may be designated as follows: P0, B11 108, B12 110, P1 112, B21 114, B22 116, P2 118, B31, B32, P3, etc. This order may be a display order of the frames. The frames may be adjacent to each other or separated by any number of frames.

In the embodiment, reference data from P1 112 may be used with respect to motion estimation in five frames, including: B11 108, B12 110, B21 114, B22 116, and P2 118. The frame P1 112 may serve as a backward reference with respect to the frames B11 108 and B12 110. The frame P1 112 may serve as a forward reference with respect to B21 114, B22 116, and P2 118.

In an embodiment, a search region 120 of a reference frame 124 is acquired. A search region 120 may include data of P1 112. The data may be transferred from external memory into the internal memory 104 using a windowing approach. The data may then be maintained in memory 104 to perform backwards and forwards motion estimation of macroblocks of multiple frames. The motion estimation may be performed using a process and the search region 120. This motion estimation may be pipelined with other video encoding operations such that real time motion estimation and encoding can be performed. The motion estimation process may be performed using the motion estimation module 100.

Temporal predictors to improve motion estimation efficiency may be selected using frames within a temporal threshold time period or a temporal threshold frame distance. The temporal threshold time period or a temporal threshold frame distance may vary depending on video standards, available memory, and hardware limitations. In the embodiment, the temporal predictors may be selected based on an adjacent frame, which may improve a motion estimation operation. Reusing a search region 120 to perform motion estimation with respect to multiple frames in a sequence including B-frames may allow multiple frames to gain the benefit of temporal predictors obtained from frames within a temporal threshold time period or temporal threshold frame distance. In particular, each frame in the sequence including B-frames may be able to obtain a predictor from an adjacent frame, which may improve motion estimation accuracy and a rate of convergence.

In an embodiment, given a macroblock in P1 112, a backward motion vector 134B of a collocated macroblock 122B in the target frame 126A, B12 110, may be determined using the search region 120. The macroblock 122A-N may include the collocated macroblock. An additional backward motion vector 134A of an additional collocated macroblock 122A in an additional target frame 128A, B11 108, may then be determined by reusing the search region 120. A forward motion vector 134C of a target frame 126B, B21 114, may be determined by reusing the search region 120. An additional forward motion vector 134D of an additional target frame 128B, B22 116, may then be determined by reusing the search region 120. In addition, a separate forward motion vector 134N of a separate target frame, P2 118, may then be determined by reusing the search region 120.

The direction of motion estimation performed to obtain each motion vector may be either forward or backward. The target frame 126A-B and the additional target frame 128A-B may each include a B-frame. The separate target frame 130 may include a P-frame. In an embodiment, the direction of motion estimation performed on the target frame 126A and the additional target frame 128A may be in the forward direction. In an additional embodiment, the direction of motion estimation performed on the target frame 126B, the additional target frame 128B, and the separate target frame 130 may be backwards.

In the embodiment, motion estimation may be performed sequentially in either a forward or a backward direction. Alternatively, motion estimation may be performed in any other order that uses a prior motion estimation result as a predictor with respect to motion estimation of another frame in a sequence that includes B-frames. Using an adjacent frame or a frame within a threshold time period or threshold number of frames may allow a motion estimation process to track a series of motion vectors through temporally related frames. Tracking the series of motion vectors may improve a reuse of the search region 120 in the reference frame 124.

In an additional embodiment, backwards motion estimation of a macroblock of B12 110 may be performed by obtaining motion estimation predictor 132B of the frame P1 112 and searching in the reference frame 124, P1 112. A forward prediction and a forward motion vector of the macroblock may be fetched from external memory to internal memory 104 to perform a bipredictive motion estimation operation. The sum of absolute differences may be used to determine a preferred method of motion estimation of a B-frame between a forward motion estimation result, a backwards motion estimation result, and a combined motion estimation result. The combined motion estimation result may be an output of a bipredictive motion estimation mode. A chosen predicted reference may be stored in external memory.

In the embodiment, backwards estimation of a collocated macroblock of B11 108 may be performed using a motion estimation predictor 132A from B12 110. A forward prediction and a forward motion vector of the macroblock may be fetched from external memory to internal memory 104 to perform a bipredictive motion estimation operation. The sum of absolute differences may be used to determine a preferred method of motion estimation of a B-frame between a forward motion estimation result, a backwards motion estimation result, and a combined motion estimation result. The combined motion estimation result may be an output of a bipredictive motion estimation mode. A chosen predicted reference may be stored in external memory.

In the embodiment, forward motion estimation of a collocated macroblock of B21 114 may be performed using a motion estimation predictor 132C from P1 112 and a search in the reference frame P1 112. A forward prediction and a forward motion vector may be stored in external memory. In the embodiment, forward motion estimation of a collocated macroblock of B22 116 may then be performed using a motion estimation predictor 132D from B21 114. The resulting forward motion vector and forward prediction may then be stored in external memory. Forward motion estimation of P2 118 may be performed using a motion estimation predictor 132N from B22 and a search in P1 112.

In an embodiment, the described methods and system to reuse the search region 120 may be performed using 195 KB of internal memory and 975 MBPS of bandwidth between external memory and internal memory. The search range in a forward or a backward direction may be +/−144 horizontally and +/−72 vertically.

In an embodiment, when encoding a B-frame based group of picture using a “PBBP” sequence with a 960 megabit per second (MBPS) external memory transfer budget, reuse of a search region 120 in motion estimation may increase a supportable vertical search range from +/−24 pixels to +/−72 pixels with respect to a B-frame. A vertical search range of a P-frame may be increased from +/−64 pixels to +/−72 pixels. The increase in vertical search range may improve a quality of video compression with respect to a substantially equivalent external memory traffic used with another method.

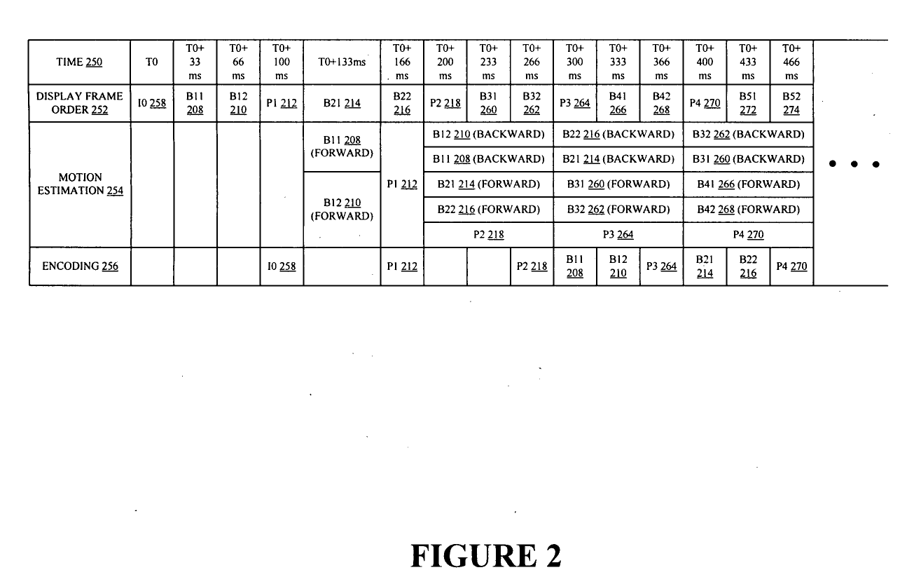

FIG. 2 illustrates pipelining of motion estimation and encoding while reusing a search region 120, according to one embodiment. In particular, FIG. 2 illustrates time 250, display frame order 252, motion estimation 254, and encoding 256, according to one embodiment. The time 250 field may illustrate a time line from a base time T0 to indicate a time of video capture and a corresponding allowable time to complete real time motion estimation and encoding operations. The display frame order 252 field may illustrate the order in which frames are displayed. The motion estimation 254 field may illustrate order motion estimation process on the frames. The encoding 256 field may illustrate the encoding order of the frame.

In an embodiment, using a time period allotted to displaying three frames to perform five motion estimation operations allows an improvement in balancing with respect to the motion estimation operations. In other embodiments, any number of time periods may be used to complete any corresponding number of motion estimation operations to perform real time motion estimation and encoding. Motion estimation operations may be balanced to provide greater time periods to perform particular motion estimation operations given that other operations may not use all of the allotted time period.

In an embodiment, motion estimation may be performed in a sequence to allow predictors from completed motion estimation operations of adjacent frames to be used to perform motion estimation of additional frames. The order of completed motion estimation operations may begin with frames closes to the reference frame and progress in either a forward or a backward direction away from the reference frame. In other embodiments, other frames may be used as a source of a predictor with respect to a motion estimation operation.

In another embodiment, encoding may be performed in which P-frames and intra coded frames are encoded in their display order, and other frames may be encoded in between the P-frames and intra coded frames. In the embodiment, B-frames are coded in their display order, but encoding operations are time delayed so that the B-frames are encoded after a P-frame that follows the B-frames in the display frame order 252.

In the example embodiment, the display order of frames may be 10 258 at time TO, followed by B11 208, B12 210, P1 212, B21 214, B22 216, P2 218, B31 260, B32 262, P3 264, B41 266, B42 268, P4 270, B51 272, and B52 274. The I0 258 may be an intra frame that is coded between T0+100 ms and T0+133 ms. Between T0+133 ms and T0+166 ms, motion estimation in the forward direction may be performed with respect to a collocated macroblock of the frames B11 208 and B12 210. Between T0+166 ms and T0+200 ms, motion estimation and encoding may be performed with respect to the frame P1 212.

In the embodiment, between T0+200 ms and T0+300 ms, motion estimation is performed in the backwards direction with respect to the frames B12 210 and B11 208, in that order. Motion estimation is performed in the forwards direction with respect to the frames B21 214, B22 216, and P2 218, in that order. Encoding is performed with respect to P2 218.

In the embodiment, between T0+300 ms and T0+400 ms, motion estimation is performed in the backwards direction with respect to the frames B22 216 and B21 214, in that order. Motion estimation is performed in the forwards direction with respect to the frames B31 260, B32 262, and P3 264, in that order. Encoding is performed with respect to B11, B12, and P3.

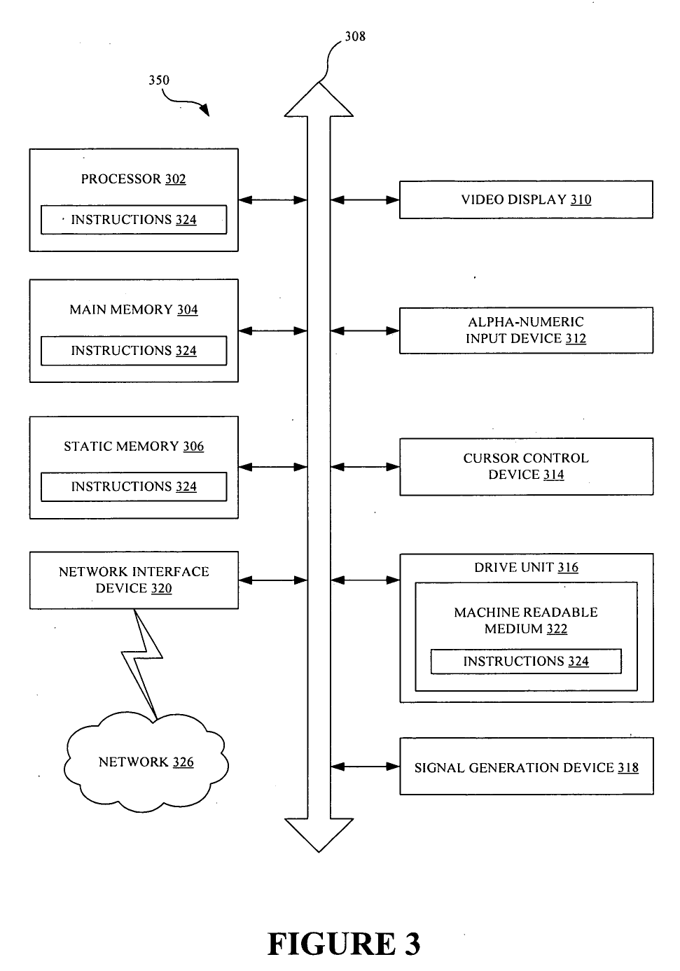

FIG. 3 is a diagrammatic system view of a data processing system in which any of the embodiments disclosed herein may be performed, according to one embodiment. Particularly, the diagrammatic system view 300 of FIG. 3 illustrates a processor 302, a main memory 304, a static memory 306, a bus 308, a video display 310, an alpha-numeric input device 312, a cursor control device 314, a drive unit 316, a signal generation device 318, a network interface device 320, a machine readable medium 322, instructions 324, and a network 326, according to one embodiment.

The diagrammatic system view 300 may indicate a personal computer and/or the data processing system in which one or more operations disclosed herein are performed. The processor 302 may be a microprocessor, a state machine, an application specific integrated circuit, a field programmable gate array, etc. (e.g., Intel® Pentium® processor). The main memory 304 may be a dynamic random access memory and/or a primary memory of a computer system.

The static memory 306 may be a hard drive, a flash drive, and/or other memory information associated with the data processing system. The bus 308 may be an interconnection between various circuits and/or structures of the data processing system. The video display 310 may provide graphical representation of information on the data processing system. The alpha-numeric input device 312 may be a keypad, a keyboard and/or any other input device of text (e.g., a special device to aid the physically handicapped).

The cursor control device 314 may be a pointing device such as a mouse. The drive unit 316 may be the hard drive, a storage system, and/or other longer term storage subsystem. The signal generation device 318 may be a bios and/or a functional operating system of the data processing system. The network interface device 320 may be a device that performs interface functions such as code conversion, protocol conversion and/or buffering used to perform communication to and from the network 326. The machine readable medium 322 may provide instructions on which any of the methods disclosed herein may be performed. The instructions 324 may provide source code and/or data code to the processor 302 to enable any one or more operations disclosed herein.

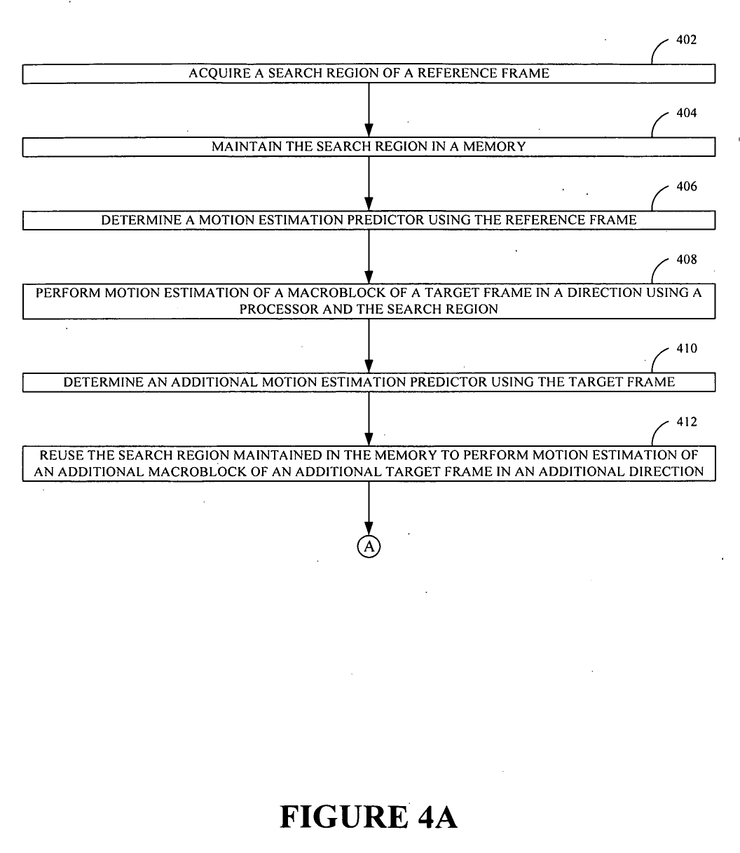

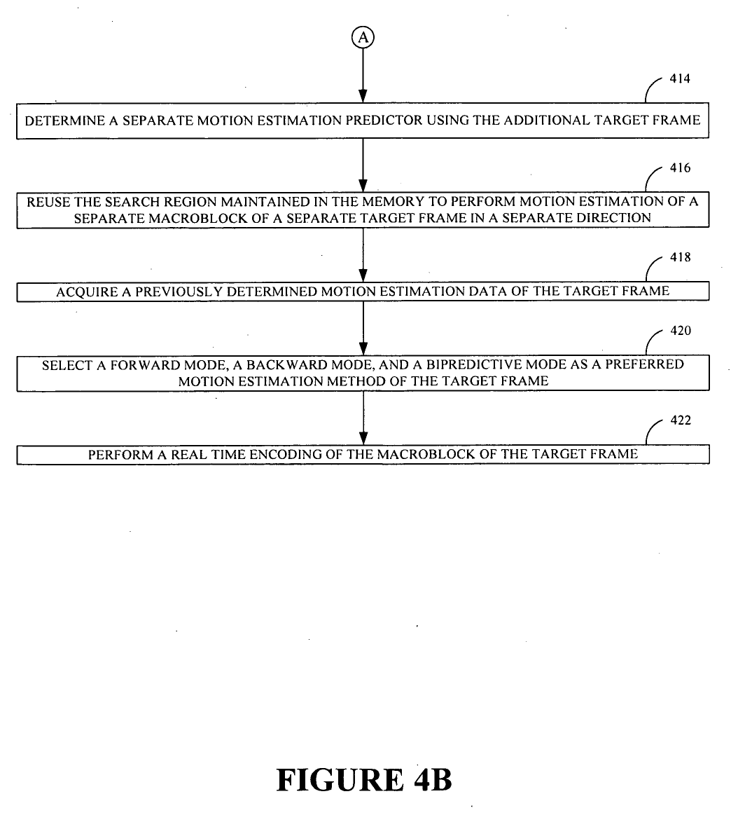

FIG. 4A is a process flow illustrating reuse of the search region 120 to perform motion estimation, according to one embodiment. In operation 402, the search region 120 of the reference frame 124 may be acquired. For example, the motion estimation module 100 may acquire the search region 120 of the reference frame 124. In operation 404, the search region 120 may be maintained in the memory 104. In operation 406, a motion estimation predictor may be determined using the reference frame 124. In operation 408, motion estimation of a macroblock of the target frame 126A-B may be performed in the direction using the processor 102 and the search region 120. The direction and the additional direction may each be in the backward direction. The target frame 126A-B and the additional target frame 128A-B may each include a B-frame. In operation 410, an additional motion estimation predictor may be determined using the target frame 126A-B. In operation 412, the search region 120 maintained in the memory 104 may be reused to perform motion estimation of an additional macroblock of the additional target frame 126A-B in an additional direction.

FIG. 4B is a continuation of the process flow of FIG. 4A illustrating additional operations, according to one embodiment. In operation 414, a separate motion estimation predictor may be determined using the additional target frame 128A-B. In operation 416, the search region 120 maintained in the memory 104 may be reused to perform motion estimation of a separate macroblock of the separate target frame 130 in a separate direction. In operation 418, a previously determined motion estimation data of the target frame 126A-B may be acquired. In operation 420, one or more of a forward mode, a backward mode, and a bipredictive mode may be selected as a preferred motion estimation method of the target frame 126A-B. In operation 422, a real time encoding of the macroblock 122B-C of the target frame may be performed. For example, the encoding operation may be performed using the encoder module 106.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry such as CMOS based logic circuitry, firmware, software or any combination of hardware, firmware, or software, which may be embodied in a machine readable medium. For example, the various electrical structure and methods may be embodied using transistors, logic gates, and electrical circuits. Examples of electrical circuits may include application specific integrated (ASIC) circuitry or Digital Signal Processor (DSP) circuitry.

Particularly, the motion estimation module 100, the encoder module 106, the quantization module, the intraprediction module, and the transform module may be enabled using software and/or using transistors, logic gates, and electrical circuits (e.g., application specific integrated ASIC circuitry) such as a motion estimation circuit, an encoding circuit, a quantization circuit, an intraprediction circuit, a transform circuit, and other circuits.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means to achieve the various operations). Accordingly, the specification and drawings are to be regarded in an illustrative rather than a restrictive sense.

What is claimed is:

1. A method, comprising:
acquiring a search region of a reference frame;
maintaining the search region in a memory;
performing motion estimation of a macroblock of a target frame in a direction using a processor and the search region; and
reusing the search region maintained in the memory to perform motion estimation of an additional macroblock of an additional target frame in an additional direction.

2. The method of claim 1, further comprising:
reusing the search region maintained in the memory to perform motion estimation of a separate macroblock of a separate target frame in a separate direction.

3. The method of claim 2, wherein the direction, the additional direction, and the separate direction are each at least one of a forward direction and a backward direction.

4. The method of claim 3, wherein at least two of the macroblock, the additional macroblock, and the separate macroblock are collocated.

5. The method of claim 4, wherein the direction and the additional direction are each comprised of a backward direction, and the target frame and the additional target frame are each comprised of a B-frame.

6. The method of claim 4, wherein the direction and the additional direction are each comprised of a forward direction, the target frame and the additional target frame are each comprised of a B-frame.

7. The method of claim 4, wherein the direction of motion estimation, the additional direction of motion estimation, and the separate direction of motion estimation is forward, the target frame and the additional target frame are each B-frames, and the separate target frame is a P-frame.

8. The method of claim 1, further comprising:
determining a motion estimation predictor using the reference frame, wherein the motion estimation of the macroblock of the target frame utilizes the motion estimation predictor, and wherein the reference frame and the target frame are adjacent frames.

9. The method of claim 8, further comprising:
determining an additional motion estimation predictor using the target frame, wherein the additional direction of motion estimation of the additional macroblock of the additional target frame utilizes the additional motion estimation predictor, and wherein the target frame and the additional target frame are adjacent frames.

10. The method of claim 2, further comprising:
determining a separate motion estimation predictor using the additional target frame, wherein the motion estimation of the separate macroblock of the separate target frame utilizes the separate motion estimation predictor, wherein the additional target frame and the separate target frame are adjacent frames.

11. The method of claim 1, further comprising:
acquiring a previously determined motion estimation data of the target frame, wherein the previously determined motion estimation data is generated by performing an alternate direction of motion estimation on the macroblock of the target frame using an alternate search region of an alternate reference frame; and
selecting at least one of a forward mode, a backward mode, and a bipredictive mode as a preferred motion estimation method of the target frame.

12. The method of claim 11, further comprising:
performing a real time encoding of the macroblock of the target frame, wherein the real time encoding is performed after the alternate search region is maintained in the memory and reused to perform motion estimation of multiple frames.

13. The method of claim 12, further comprising:
causing a machine to perform the method of claim 12 by executing a set of instructions embodied by the method of claim 12 in a form of a machine readable medium.

14. A system, comprising:
a motion estimation module to acquire a search region of a reference frame;
a memory to maintain the search region; and
a processor to perform motion estimation of a macroblock of a target frame in a direction using the search region and to reuse the search region maintained in the memory to perform motion estimation of an additional macroblock of an additional target frame in an additional direction.

15. The system of claim 14, wherein the processor reuses the search region maintained in the memory to perform motion estimation of a separate macroblock of a separate target frame in a separate direction.

16. The system of claim 15, wherein the direction, the additional direction, and the separate direction are each at least one of a forward direction and a backward direction.

17. The system of claim 16, wherein at least two of the macroblock, the additional macroblock, and the separate macroblock are collocated.

18. The system of claim 17, wherein the direction and the additional direction are each comprised of a backward direction, and the target frame and the additional target frame are each comprised of a B-frame.

19. A method, comprising:
acquiring a search region of a reference frame;
maintaining the search region in a memory;
determining a motion estimation predictor using the reference frame, wherein the motion estimation of the macroblock of the target frame utilizes the motion estimation predictor, and wherein the reference frame and the target frame are adjacent frames;
performing motion estimation of a macroblock of a target frame in a direction using a processor and the search region, wherein at least two of the macroblock, an additional macroblock, and a separate macroblock are collocated;
reusing the search region maintained in the memory to perform motion estimation of the additional macroblock of an additional target frame in an additional direction;
reusing the search region maintained in the memory to perform motion estimation of the separate macroblock of a separate target frame in a separate direction, wherein the direction of motion estimation, the additional direction of motion estimation, and the separate direction of motion estimation is forward, the target frame and the additional target frame are each B-frames, and the separate target frame is a P-frame;
acquiring a previously determined motion estimation data of the target frame, wherein the previously determined motion estimation data is generated by performing an alternate direction of motion estimation on the macroblock of the target frame using an alternate search region of an alternate reference frame;
selecting at least one of a forward mode, a backward mode, and a bipredictive mode as a preferred motion estimation method of the target frame; and
performing a real time encoding of the macroblock of the target frame, wherein the real time encoding is performed after the alternate search region is maintained in the memory and reused to perform motion estimation of multiple frames.

20. The method of claim 19, further comprising:
determining an additional motion estimation predictor using the target frame, wherein the additional direction of motion estimation of the additional macroblock of the additional target frame utilizes the additional motion estimation predictor, and wherein the target frame and the additional target frame are adjacent frames; and
determining a separate motion estimation predictor using the additional target frame, wherein the motion estimation of the separate macroblock of the separate target frame utilizes the separate motion estimation predictor, wherein the additional target frame and the separate target frame are adjacent frames.
